(19) United States
(12) Patent Application Publication
(10) Pub. No.: US 2005/0056516 A1
(43) Pub. Date: Mar. 17, 2005

(54) Transmission quill repair sleeve

(76) Inventor: Joel Reagan Cox, Northglenn, CO (US)

Correspondence Address: JOEL REAGAN COX, 1006 W 104TH AVE #164, NORTHGLENN, CO, 80234, US

(21) Appl. No.: 10/893,036

(22) Filed: Jul. 16, 2004

Related U.S. Application Data
(60) Provisional application No. 60/487,762, filed on Jul. 16, 2003.

(51) Int. Cl. F16D 23/14

(52) U.S. Cl. 192/98; 192/110 B

(57) ABSTRACT

A repair sleeve (7) made of hard metal with a smooth finish to provide a new surface (8) for an oversize bearing (11) to be installed. The sleeve (7) is anchored to the quill (1) using a method such as an anchor screw (10) commonly a set screw or number thereof, but possibly a form of clamp or similar device, depending upon clearance issues per application.

### CROSS-REFERENCE TO RELATED APPLICATIONS

This application claims the benefit of provisional patent application Ser. No. 60/487,762, filed 2003 Jul. 17 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention produces a viable repair for damage to the quill area on automotive transmissions.

2. Prior Art

A quill is a protrusion of the transmission case. There are other names used to identify this area, such as, snout, bearing carrier, bearing support tube, guide member, boss, etc. In some cases the quill is a separate and removable part. The damage to this area is caused by various means:
(a) Loss or lack of lubrication causes friction resulting in loss of material on the surface area.
(b) Conflict of materials, such as steel against aluminum.
(c) Most clutch release bearings have a plastic or polymer type of material lining the bore. While this provides a smooth surface to glide on, it tends to become impregnated with the aluminum particles from the deterioration of the quill. This compounds the problem rapidly because it now becomes an abrasive surface. It causes binding and thus increasing pedal pressure. It can also cause a jerky, inconsistent clutch engagement.
(d) Operator error usually caused by applying pressure to the clutch pedal constantly, commonly referred to as, riding the clutch. This causes the clutch release bearing to spin at engine speeds. The design is intended for momentary engagement of the said bearing for the purpose of disengaging the clutch while shifting gears or at a stop. The resulting vibration increases the wear pattern rapidly.
(e) Improper clutch adjustment can cause the same effect as explained in (d).
(f) Damaged clutch pressure plate can cause contact with the said bearing causing the same effect as stated in (d).
(g) Imbalance and vibration can contribute to the damage also.

The previous alternative was to have the quill area machined and install a sleeve over the quill so as to provide a smooth surface for linear movement of the clutch release bearing. In some instances the quill is removable and may be repaired in such a manner feasibly.

Whereas this is a viable repair, the method is prohibitive for several reasons:
(1) Costs is substantial for numerous reasons:
   (a) Machining in itself is expensive.
   (b) Requires removal and transporting of the transmission.
   (c) Replacement of the transmission case is time consuming and expensive. This also does not eliminate the problem. The design is the problem.
   (d) Replacement of the transmission as a whole, either new or used is costly.
(2) Manufacturers, such as the Subaru, early Volkswagen and Porsches, have a split case design or clamshell. The installed sleeve would have to be removed resulting in damages to the sleeve and/or transmission. After the repairs were made the process would have to be repeated increasing costs and time again. Not uncommon is the scenario, where the repairs were not done properly and the transmission has to come apart again to correct the problem. How many times will the process be repeated?
(3) Time is of the essence in most repair facilities. This is a very time consuming process. The shop and mechanic are delayed while the repairs are being made. The customer is out the use of their vehicle, possibly rental car charges.
(3) In most instances the transmission must be disassembled to allow the repairs. In the cases referred to in (2) this cannot be done. This would require a machine shop with a lathe or equipment to be able to spin the whole transmission to allow the turning down of the quill.

One solution that would seem apparent is U.S. Pat. No. 4,808,015 to Babcock 1989 discloses a clutch release bearing with a sleeve as part of the said bearing. While this is a good alternative at the time of manufacture, it cannot be viewed as a repair once the damage is done for the following reasons:
(a) The sleeve is free to travel with the linear movement of the bearing.
(b) No means of anchoring the sleeve is provided for. The implication is that enough buildup will eventually occur to cause binding between the sleeve and the quill and not allow it to move.
(c) The sleeve would almost immediately conform to the shape of the quill and become deformed in the region of the damage.
(d) There are issues with heat buildup to the plastic or polymer sleeve that would change the clearances dramatically.
(e) If the sleeve did become bound on the quill as implied, would it be safely removable and re-useable if the transmission was in need of repairs?
(f) Viable costs would be an issue, as a special bearing would have to be made for each application. To justify the expenditure of tooling a large quantity would have to be ordered.

3. Objects and Advantages

Accordingly, besides the objects and advantages of the methods described in my above patent, some objects and advantages of the present invention are:
(a) that it provides a low cost alternative vs transmission replacement.
(b) that machining is not required.
(c) that removable of the transmission is not required.
(d) that it allows removal and reuse of the sleeve.
(e) that is anchored in some manner, stationary.
(f) that it provides an excellent surface to facilitate a smooth engagement.
(g) that time is better utilized here, allowing scheduled completion
(h) that it provides a hard smooth surface for linear bearing travel.
(i) that it allows short runs, keeping manufacturing costs down.
(j) that it adds to customer satisfaction.

Further objects and advantages will become apparent from a consideration of the ensuing description and drawings.

### SUMMARY

In accordance with the present invention a replacement sleeve providing a low cost, viable alternative to an ongoing problem.

### DRAWINGS—FIGURES

FIG. 1 shows a typical transmission quill with a typical clutch release bearing in place.

FIG. 2 shows a simulation of typical damage to a transmission quill.

FIG. 3 shows a drawing of my repair sleeve.

FIG. 4 shows my repair sleeve installed on a damaged quill and the clutch release bearing in place.

### DRAWINGS—REFERENCE NUMERALS

1 quill 2 quill bearing surface

3 clutch release bearing 4 bearing sleeve

5 linear movement 6 damaged area

7 repair sleeve 8 sleeve surface area

9 flange 10 anchor screw

11 oversize clutch release bearing

### DETAILED DESCRIPTION—1 AND 2

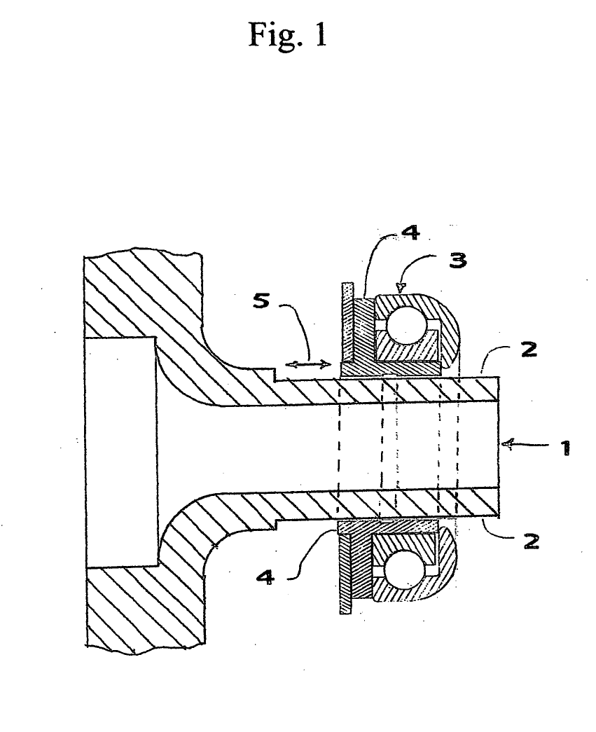

FIG. 1 is a drawing of a typical quill 1 as part of a transmission case with a typical clutch release bearing 3 in place. The quill has a bearing surface area 2 that is the focus of the invention. The bearing 3 has a sleeve 4 for the inner bore. Typically this sleeve 4 is made of some type of plastic or polymer, although some are made of steel. The bearing 3 slides on a linear path on the quill surface 2 in the operation of the clutch engagement and disengagement.

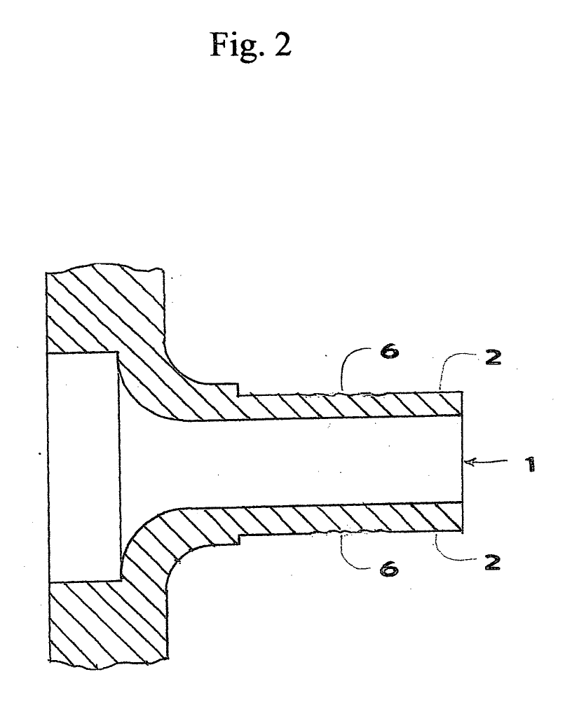

FIG. 2 is a illustration of the typical damaged area 6 of the quill bearing surface 2 that occurs due to causes explained in BACKGROUND OF THE

### INVENTION—PRIOR ART (a)-(g)

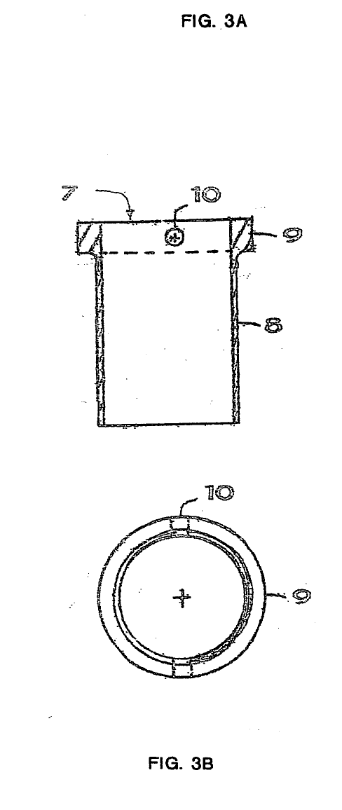

### DETAILED DESCRIPTION—FIGS. 3A AND 3B

### PREFERRED EMBODIMENT

A preferred embodiment of the repair sleeve 7 is shown longitudinally in FIG. 3A and the end view in FIG. 3B. The material of choice is stainless steel, although not required. The sleeve surface area 8 provides a smooth hard surface for the oversize clutch release bearing 11 to slide on. The flange 9 shows a method of providing an anchor screw 10 for anchoring the sleeve 7 to the original quill surface 2. Other means of anchoring or retaining may be used, such as a clamp, etc.

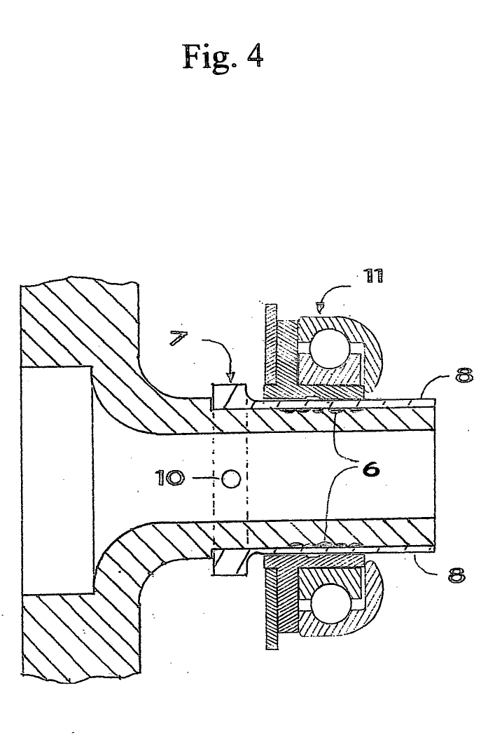

### DETAILED DESCRIPTION-FIG. 4—OPERATION

The repair process involves sliding the repair sleeve 7 over the damaged area 6 of the quill 1 and anchoring it with the anchor screw 10. Then the oversize clutch release bearing 11 is installed over the sleeve 7.

1. A repair sleeve made from a hard material for the purpose of providing a new smooth surface to be installed over the damaged area of the transmission quill.

2. The sleeve of claim 1 wherein said sleeve is preferably made of stainless steel, although there are other suitable metals, for it's rust inhibiting feature and the ability to machine it to a mirror-like finish.

3. The sleeve of claim 1 wherein said sleeve is to be provided with an anchoring method such as but not limited to, set screws, one or multiple, clamp(s), bolts, etc.

4. The sleeve of claim 1 wherein shall be of sufficient thickness so as to prevent it conforming to the damaged area.

5. The sleeve of claim 1 wherein shall be provided with an oversize clutch release bearing as part of the repair kit.

6. The sleeve of claim 1 wherein shall be removable and reusable so as to facilitate repairing of the transmission in the event of the case having to be split in half, as with Subaru transmissions.

7. The sleeve of claims 2 wherein shall not cause damage in the removal process.

8. The method of repairing a damaged transmission quill, comprising:
(a) providing a repair sleeve designed to slip over the damaged transmission quill.
(b) providing an oversize clutch release bearing for said sleeve.
(c) providing an anchoring method to secure said sleeve to the quill. Various methods may be incorporated in this task.
(d) providing a method to facilitate removal without damage to the transmission.
(e) providing a method to incorporate anything else that may be needed in a particular application.
